(19) United States
(12) Patent Application Publication
(10) Pub. No.: US 2009/0207635 A1
(43) Pub. Date: Aug. 20, 2009

(54) Standby Operation of a Resonant Power Convertor

(75) Inventor: Reinhold Elferich, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,079

(22) PCT Filed: May 11, 2005
(86) PCT No.: PCT/IB2005/051553

§ 371 Date: Nov. 14, 2006

(30) Foreign Application Priority Data
May 18, 2004 (EP) 04300292.2

(51) Int. Cl. H02M 3/335

(52) U.S. Cl. 363/21.03

(57) ABSTRACT

A control method is proposed that enables to drive a resonant (LLC) power converter at low loads with substantially reduced power losses for realizing a stand-by power. The reduction is achieved by a sub-critical operation several times below Resonance Frequency while still keeping zero voltage switching. One half-bridge switch (s1) is turned on for a short pulse—in the remaining time of the sub-critical switching period the resonant current oscillates through the other switch (s2). Zero voltage switching is obtained by evaluating the resonant capacitor voltage. The pulse length determines the stand-by power and is used as controlling variable. The power supply is suitable for Consumer Electronics products that require a low power standby supply.

### FIELD OF THE INVENTION

The present invention relates to a power supply. In particular, the invention relates to a standby mode of operation of a resonant type of power supply.

Moreover the present invention relates to standby power supply of a resonant type of power supply that has low power losses at little to no additional cost.

The present invention is particularly relevant for devices that require a normal power supply as well as a low power standby mode such as Consumer Electronics devices.

### BACKGROUND OF THE INVENTION

Low Power Standby (LPS) functionality in high volume applications, such as consumer or office electronics, using a resonant power supply is quite new. Several concepts have been looked at in the prior art for stand-by operation for a resonant type of power supply (typically an LLC type of converter).

In a first concept, the power supply operates close to its no-load point. As a consequence, in case of a maximum mains voltage maximum switching frequency for the resonant type of power supply, there still will be considerable reactive current causing losses in the half-bridge and in the transformer (particularly in designs aiming at world-wide mains). These losses will be due to frequency dependency of losses in a driver and in a transformer of such a power supply. The losses in this mode may be a multiple of the required standby power.

In a second concept the resonant type of power supply operates in a burst mode operation. In this case the resonant type of power supply is completely switched off periodically. During a switch on process, hard switching cannot be avoided. Furthermore, a control loop in a burst mode operation locks only after a while in which timeslot no power can be converted. This further decreases efficiency of power conversion and it requires larger output filter. It would take quite some effort to design the burst mode operation.

A last concept requires an additional converter that is only operational in stand-by mode. Obviously this brings additional components and costs.

### SUMMARY OF THE INVENTION

It is, accordingly, an object of the present invention to provide a resonant power supply that comprises a standby power supply and/or a light load operation mode.

It is another object of the invention to provide a resonant power supply that comprises a standby power supply with little power loss, little to none additional cost and that is easy to design.

Another object of the invention is to provide a resonant power supply that can be driven at low loads and exhibiting a substantially reduced power loss.

It is also an object of the invention to provide a power supply driver integrated circuit for a resonant power supply that comprises a standby power supply and/or a light load operation mode.

It is yet another object of the invention to provide a system that has a resonant power supply that comprises a standby power supply.

Yet another object of the invention is to provide a method to control a resonant power supply that comprises a standby power supply and/or a light load operation mode.

In order to achieve these and other objects, the inventor proposes in one preferred embodiment, a resonant power supply operating in sub-critical mode (i.e., far below Resonance Frequency (f0)) but keeping zero voltage switching, and thus switching virtually loss-less. Start-up losses are avoided, which would permanently occur due to hard switching events in any burst mode operation.

In another preferred embodiment, the inventor proposes to switch off one or more outputs while keeping one or more others in stand-by mode (in case of a converter with at least two outputs). This will save power switches at a secondary side of the resonant power supply. A resonant power supply with dual output control has been described in related patent applications (see attorney dockets PHDE010138 and PHDE010249).

A conventional resonant power supply design is mainly determined by no- or light-load operation at maximum input voltage. Since the power deliverable in the proposed sub-critical operation mode can cover such a light load operation as well, the converter design has yet only to cope with nominal and peak power. This in turn results in a simplified transformer and eventually in reduced inverter currents.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1a shows a typical diagram of a resonant power supply with a non-grounded (left) and a grounded resonant capacitor (right);

FIG. 1b shows a (prior art) typical low load (or stand-by) waveforms of a resonant power supply by operating far above resonance;

FIG. 2a shows building blocks of a resonant power supply in accordance with the invention;

FIG. 2b shows waveforms of a resonant power supply in accordance with a preferred mode of the invention with a sub-critical low load (stand-by or low load) operation several times below Resonance Frequency.

FIG. 3 shows waveforms details of FIG. 2 between t0 and t1 of a resonant power supply in accordance with the invention;

FIG. 4 shows a resonant power supply, in accordance with the invention, with two half-wave rectified outputs with a stand-by mode that does not require an output power switch in stand-by mode;

FIG. 5 shows a flowchart diagram of normal and standby mode operation of a resonant power supply in accordance with the invention;

FIG. 6 shows a flowchart diagram of standby mode operation of a resonant power supply in accordance with the invention; and

FIG. 7 shows a flowchart diagram of standby mode operation switching of a resonant power supply in accordance with the invention.

Throughout the drawings, the same reference numeral refers to the same element, or an element that performs substantially the same function.

### DETAILED DESCRIPTION OF THE INVENTION

This section describes a detailed description of a best mode for implementation of the invention.

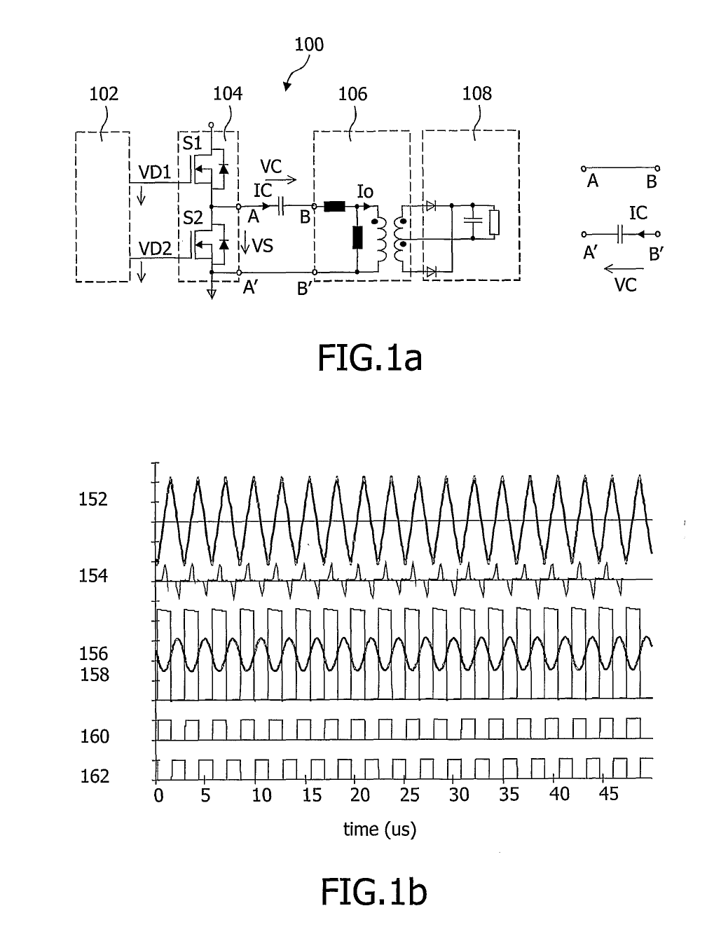

FIG. 1a shows a resonant power supply 100 with a non-grounded (left) and a grounded resonant capacitor (right). Resonant power supply 100 comprises driver/controller 102, half-bridge 104, transformer 106 and output/load 108. In power supply 100, an inverter is formed by a half-bridge 104 (with S1, S2), which is the most usual configuration. A person skilled in the art will understand that the invention applies to a full-bridge converter as well. A full-bridge converter may be advantageous for applications that require a higher output power and/or universal mains input voltage. Other configuration may be used as well.

FIG. 1b shows prior art characteristic waveforms at stand-by operation of resonant power supply 100. FIG. 1b shows capacitor (input) current IC 152, reflected output current Io (×10) 154, capacitor voltage VC (bold) 156, switch node voltage VS 158, driver voltage VD1 160 and driver voltage VD2 162. Most of the capacitor's current IC is reactive since only a small fraction Io is converted to the output.

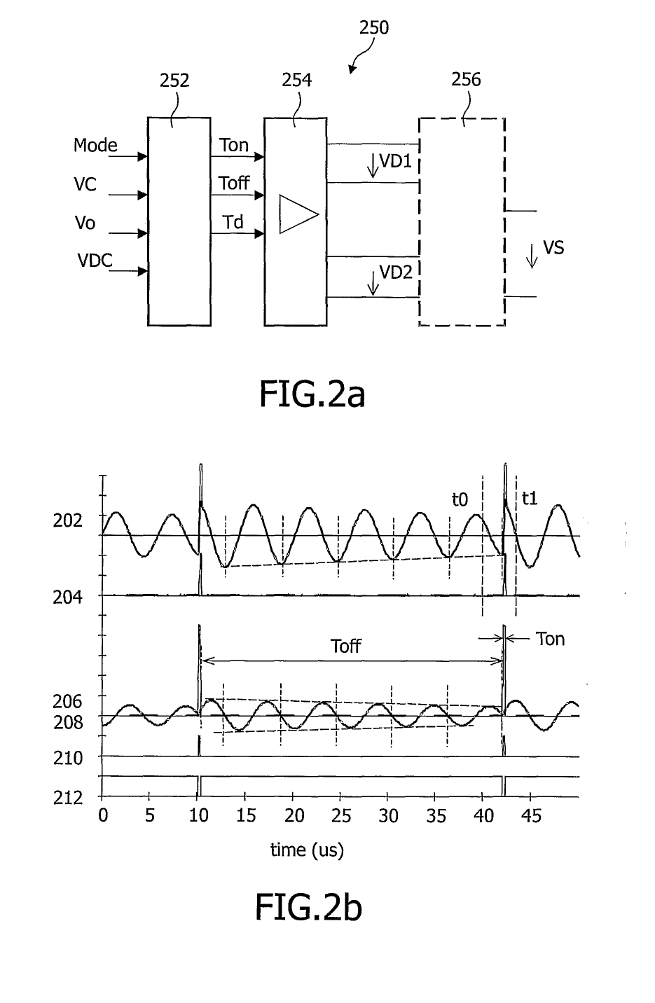

FIG. 2a shows building blocks 250 of a resonant power supply in accordance with the invention. Building blocks 250 comprise a control block 252 (e.g., SBM-control: Stand-By Mode-control), a driver 254 and an inverter formed by half bridge 256 (which comprises switches S1 and S2, a common configuration). Instead of a half bridge, a full-bridge is possible too and can be advantageous for higher output power and/or universal mains input voltage.

Regarding implementation, any combination of the blocks could form an individual IC (Integrated Circuit). The most preferable solutions would be integration of control block 252 and driver 254 or of all three blocks 252, 254 and 256. This IC may preferably comprise more functions like its own supply means, the output voltage control in normal operation, overcharge protection (voltage, current, power, temperature), capacitive mode protection, or others. For reasons of clarity, only input- and output-signals and signal processing blocks used for control block 252 are shown. Some of the signals may be already acquired for other functions too. VC e.g., can be used for over power protection. Vo (output voltage in case the resonant power supply has a single output) is typically already used for output voltage control. The way that signals VC and V-out are sensed and provided to the control block 252 are well known by a person skilled in the art.

The proposed SBM refers in particular to driving and sensing a resonant power supply, as shown and explained using the following Figures. In a typical embodiment, no additional elements are required in the circuitry of a resonant power supply.

Mode can indicate that one of the following operations is required a) stand-by, b) normal operation. Two additional, e.g., optional operation modes c) start-up and d) light-load can either be derived from VDC and/or V-out or as well be determined by the mode signal.

VC is used to watch the transient state of the resonant power supply in order to determine the switching times. Although sensing the resonant capacitor's voltage is probably the cheapest way, measuring alternatively the capacitor's current is possible, too. In case of this solution the following signal processing has to be adapted: maximum of VC translates to negative zero crossing of IC, and negative corresponds to zero crossing of VC to minimum of IC.

Vo is the output voltage in case the resonant power supply has a single output. In case of a DOC(Dual Output Control), Vo is either again a single output voltage (namely that one providing the standby) or V-out comprises two output voltages Vo1 and Vo2, which are the directly controlled output voltages of the DOC. The latter option is used for the start-up and light-load mode. (The value, the controller actually requires is rather the control error ΔVo=Voref−Vo; so usually not Vo is fed back but ΔVo).

VDC is most likely already a power input of the control/driver IC. However it may be used as a signal for the start-up mode as well.

T-on is the on-time signal of the switch S1. (The real on time differs in general due to gate-delays and rise times.) T-off is the on-time signal of the switch S2.

T-d is the so-called dead time when none of the switches is supposed to be conductive. These three parameters are the controlling variables of the power supply. The other above-mentioned functions either take over the control if none of the SBM modes are required or—in case of the protection functions—they may be active at the same time.

FIG. 2b shows a proposed sub-critical low load (e.g., stand-by) operation several times below Resonance Frequency in accordance with an embodiment of the present invention. FIG. 2b shows capacitor (input) current IC 202, reflected output current Io 204, capacitor voltage VC (bold) 206, switch node voltage VS 208, driver voltage VD1 210 and driver voltage VD2 212. The ON-time functions as controlling variable. The OFF time (Toff) still arranges for zero voltage switching of the half-bridge by (e.g.) referring to the capacitor voltage VC only in terms it's of peak value and zero crossing. In FIG. 2b, corresponding current- and voltage-waveforms are displayed for the same converter and the same period of time resulting from applying the proposed controlling scheme.

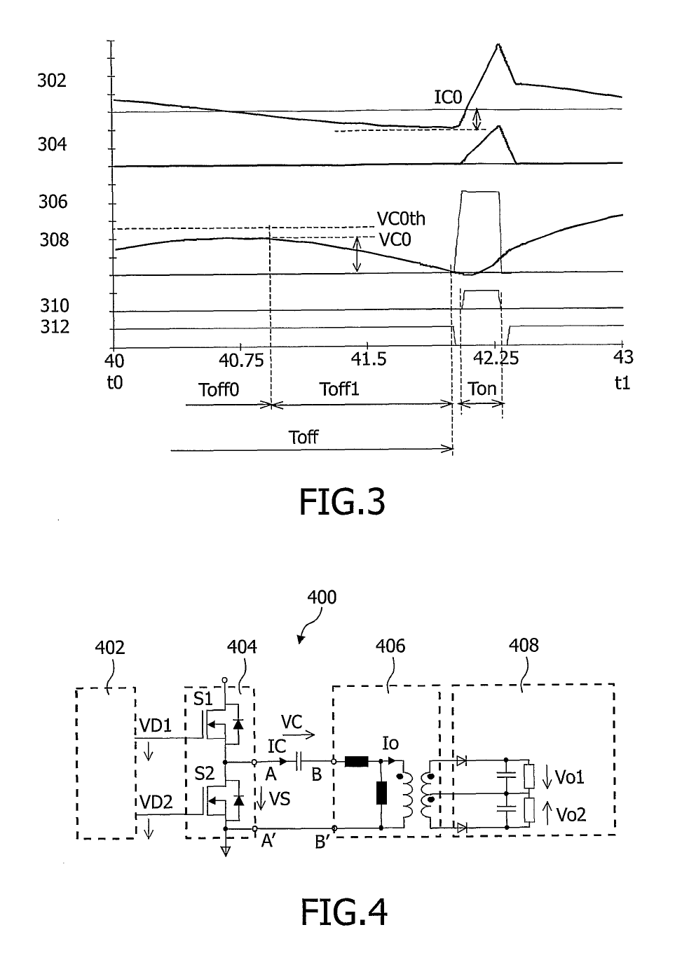

FIG. 3 shows in more detail one switching action of FIG. 2b. FIG. 3 shows capacitor (input) current IC 302, reflected output current Io 304, capacitor voltage VC (bold) 306, switch node voltage VS 308, driver voltage VD1 310 and driver voltage VD2 312. The ON-time period determines the stand-by power delivered to the output. When Ton is bigger than P-output is bigger and vice versa. Since Toff enables switching only at negative zero crossing of VC which maintains ZVS and at a given minimum required inductive current IC0 by measuring VC0 falling short of a given threshold VC0th. The stand-by mode (SBM) is accomplished by keeping switch S2 closed (VD2 high) and S1 open (VD1 low), which results in waveforms of a LC oscillator with a certain damping. During this time the capacitor voltage VC is monitored. If its peak value VC0 falls—due to damping—short of a given threshold VC0th (after time Toff0) the bridge is switched on as soon as the next negative zero crossing of VC is detected (after further time Toff1). The dead time is adjusted in the known manner. The On-time Ton of S1 is used as the variable controlling the output voltage in SBM, because it determines the energy delivered to the output. The threshold VC0th corresponds to the negative peak value of capacitor (input) current IC and ensures zero voltage switching. It is determined by the resonant capacitor and the output capacitance Coss as specified for the switches S1 and S2.

IC0 can be used for enabling so-called soft-switching or more specific ZVS. This means when switching the upper/lower switch S1/S2, a current is immediately flowing in advance to the switching event through the body diode (or intrinsic body diode) of the MOSFET (or discrete diode in case of bipolar). In terms of a series capacitor connected to the switch node, the current IC must therefore show a negative/positive sign. Due to parasitic capacitances of the switches (so-called Coss, or output capacitance) a minimum current is required to completely charge/discharge that capacitance before the diode is forward biased. The limiting value is the amount of charge required. Thus, the minimum current depends on the dead time and the Coss characteristics of the switches. In order to limit on the other hand the maximum dvdt at the switch node at max load operation, sometimes even additional capacitors are connected in parallel to the switches (snubber capacitances).

The VC0th control implies that, in event an extremely low power is required at the output (let say below some 10 mW), the frequency (VC0th) may be so much reduced that not enough current IC0 is left in advance to the switching event for a complete ZVS to be possible. This however is still better than hard switching.

The switching frequency in the proposed sub-critical mode in the example of FIG. 2b is 1/(Ton+Toff), about 31 kHz, as opposed to about 350 kHz in prior art FIG. 1b. Compared to the conventional (prior art) low load operation shown in FIG. 1b the switching frequency at the same output power has been reduced to less than 9% and the rms-value of the primary current to 35%. A resonant power supply, comprising an LLC converter, has a Resonance Frequency (or so-called ‘no-load resonance’) f0=1/(2 pi sqrt(C*(Ls1+Lm))) with C is the resonant capacitance, Lm is the mutual inductance, and Ls1 the primary series inductance. Resonance Frequency (f0) is the resonance (characteristic) frequency of the converter if the load current is zero. The switching frequency at normal operation is always bigger than f0) (i.e. over-critical), but it depends on the design, specifications, and operation conditions. It can be close to f0 in case of high coupling, gain and output power. In case of low coupling, gain and output power, it can go up to, say 10. Start-up switching frequency can be, within known start-up control means, even several times above the rated maximum normal (steady-state) switching frequency, which is given by the minimum output power and at maximum input voltage (i.e. at minimum gain).

The SBM operation frequency typically lies below f0.

In SBM, the converter is excited with pulses, shorter than one half-cycle of the load resonant frequency. After such a pulse, the converter oscillates either immediately with Resonance Frequency (in all cases except start-up) or for several further cycles with load-resonance and then continues oscillating at no load resonance.

Since the SBM approach assumes a moderately damped system, the number of periods between SBM switching events may be 2 to 20 (with 2 refers to start-up mode, otherwise 4 to 20).

In SBM, only one of the output rectifier diodes of the converter in FIG. 1a is conducting because the voltage at the transformer's main inductance becomes highly asymmetric according to the extreme duty cycle with which the converter is excited.

FIG. 4 shows a related converter of another embodiment of a resonant power supply 400 (a related converter) that makes use of the circumstance described in the previous two paragraphs. Resonant power supply 400 comprises driver/controller 402, half-bridge 404, transformer 406 and output/load 408. Resonant power supply 400 (shown with a Dual Output Control or DOC) experiences at one output (Vo2) a quasi switch-off while the other output Vo1 keeps its nominal voltage. FIG. 4 shows resonant power supply 400 with two, half-wave rectified, outputs (DOC). During stand-by operation at output Vo1, the voltage Vo2 lessens to about 1/10 of its nominal value. A power switch (which is usually employed if that output has to be disconnected from the load in stand-by mode) can therefore be saved. In case of the DOC, the output filters are suitable already for nominal operation with the half-wave rectification waveforms. In that case, the ripple current usually determines the size of the capacitors, at least in case of electrolytic types, so that the resulting ripple voltages are negligible. A resonant type of power supply with dual output control has been described in prior art (PHDE010138, PHDE010249). An output switch is typically required when an output must be disconnected from the load in stand-by mode in a conventional resonant power supply.

Another preferred embodiment of the invention comprises a variation of the control method. Keeping the pulse length constant and varying the switching frequency can control the SBM output voltage as well. An advantage of this method is that the pulse length can be set to a practical minimum. The advantage of the above feedback is that minimum current operation is always ensured.

A similar control scheme can be applied with reverted signals for S1 and S2. This means that by default, S1 is conducting and S2 is closed only for a pulse. Then, VC oscillates with the same amplitude but the offset equals instead of slightly about zero slightly below dc input voltage of the half-bridge.

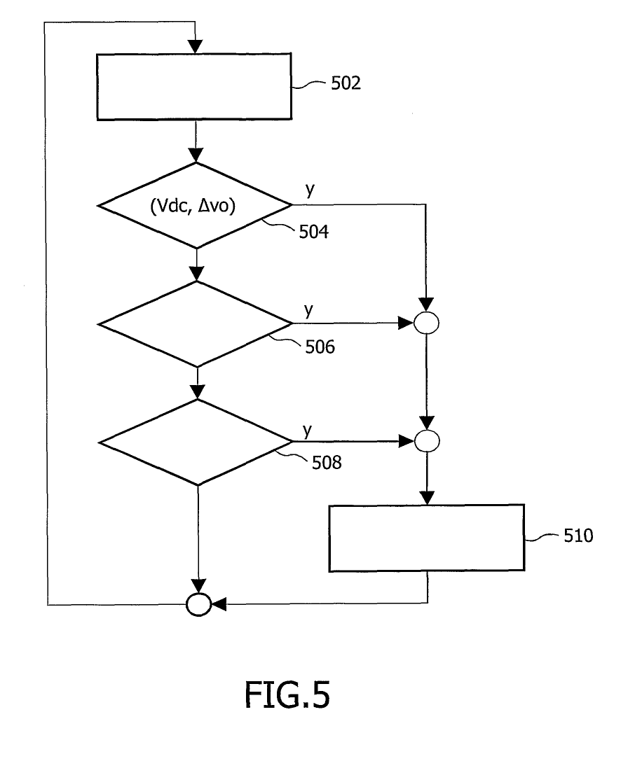

FIG. 5 shows a flowchart diagram of normal and standby mode operation of a resonant power supply in accordance with the invention. SBM control (driving sequence)

A SBM operation has a sub-critical Ton-controlled zero voltage switching. FIG. 5 describes a first of three flowcharts representing three levels of hierarchy of a preferred SBM operation. FIG. 5 depicts the highest level of the hierarchy of operation. Assuming the system is running in a normal operation mode (e.g., the system supplies a typical output power), state NOM 502, which may be the default state of a controller, it can switch to state SBM (Stand By Mode) 510 through three conditions. A first condition is the start-up condition, SUC 504. SUC 504 is either is set externally or as well derived internally by means of evaluating a control error (Δvo=voref−vomes) and/or an inverter's intermediate dc-link voltage Vdc. Further conditions are the standby case, which is either externally set and checked in condition ExtSBMC 506 or again, internally derived e.g. by monitoring the switching frequency fs in normal operation mode. When fs exceeds a certain limit (e.g. 1.2 to 2 times the rated fs at full load), condition intSBM1 508 is fulfilled. There is no need to further distinguish between rated standby mode operation and light-load operation. Once the SBM has been activated, further conditions are checked therein to return to state NOM 502.

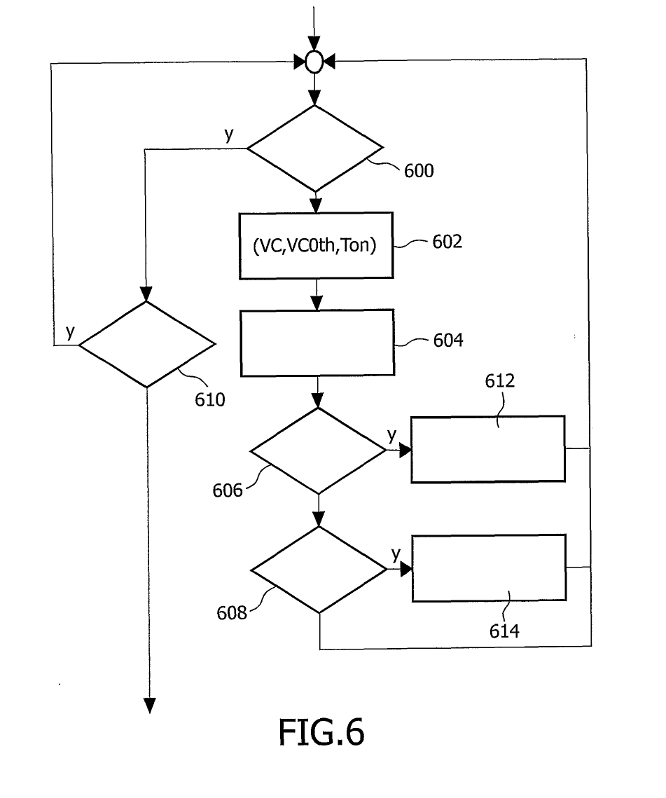

FIG. 6 shows a flowchart diagram of standby mode operation of a resonant power supply in accordance with the invention. State SBM 510 of FIG. 5 is shown descended in hierarchy in the flowchart of FIG. 6. An outer loop in SBM comprises a check of condition intNOMC2 600, a state SBMS 602, a state T0n=Lim 604, a check of condition Ton<=Tonmin 606, a state dec(VC0th) 612, a check of condition Ton>=Tonmax 608 and a state inc(VC0th) 614. In FIG. 6, condition intNOMC2 600 is assessed steadily, which decides the return to state NOM 502. Condition intNOMC2 600 can be, e.g., VC0th-max<VC0th-min, or fs>fsSBM-max, or refer to the control error. This will be explained below. Limits, VC0th-max and fsSBM-max, define the maximum power deliverable in SBM while still being capable to keep the control error virtually zero. However, before returning to state NOM 502 another condition may not be true, which is the case of condition SUC (Start Up Condition) 610. Condition SUC 610 may be set by state NOM 502 in terms of a predefined time interval (pulse, long enough to charge the output capacitor(s) with that max SBM power). As long as it lasts the system is supposed to run in SBM at a predefined power limit regardless of the instantaneous control error.

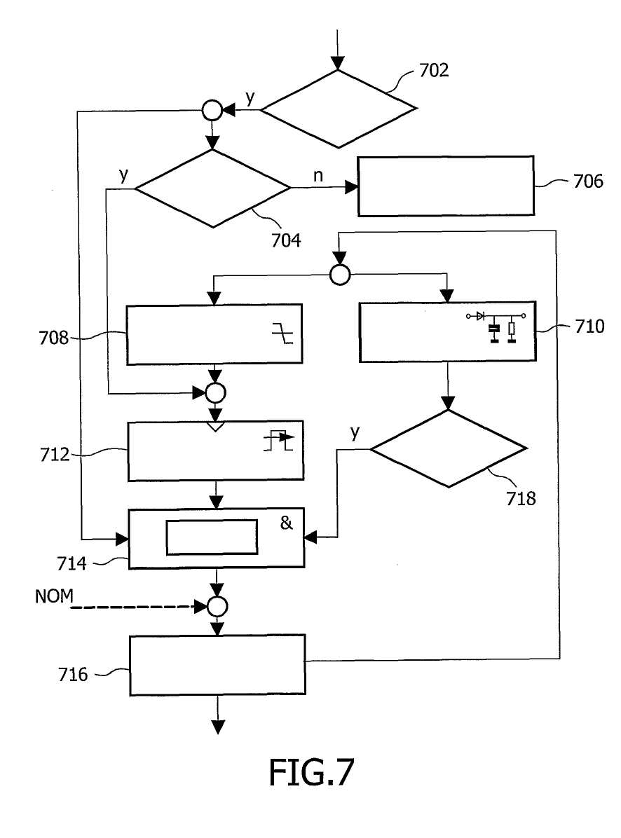

FIG. 7 shows a flowchart diagram of standby mode operation switching of a resonant power supply in accordance with the invention. If the actual state SBMS 602 (SBM Switching routine) is active (descended in FIG. 7), a recursion is running having two controlling variables. In the inner loop Ton is controlling the output voltage by means of e.g. a P, PI, or PID controller in state T0n=Lim 604. In the outer loop, it is monitored if Ton is running at one of its predefined limits (Ton<=Tonmin 606, Ton>=Tonmax 608). Alternatively, a value corresponding to Ton or an associated value like Δvo may be evaluated. Anyway, running of Ton at one of its limits indicates that either too much or too little power is converted (and adjusted accordingly in state dec(VC0th) 612 and state inc(VC0th) 614). Limitation of Ton however, is unavoidable (ZVS condition at switching off, minimum obtainable pulse length at inverter). Therefore, a second control variable is used. This is the SBM switching frequency or the number of oscillation periods between two switching events. In the example, VC0th is used as the manipulating variable. VC0th corresponds to that number of periods since a damped system can be assumed. VC0th is initialised at a predefined value in state VC0th=VC0th0 706, which still enables ZVS in SBM according to the inverter characteristics in terms of Coss. VC0th (and thus the switching frequency) is increased/decreased if Ton runs at Tonmax/Tonmin. This procedure is explained in FIG. 7, which descends state SBMS 602. State SBMS 602 starts running as soon as condition SBMC 702 (=one of the SBM conditions) is true. Since the previous state may be a non-running or switched-off converter, condition SBMCon 704 detects a rising edge on SBMC. An initial Ton pulse in state Pulse(Ton) 712 is triggered and VC0th is initialised in state VC0th=VC0th0 706. State Pulse(Ton) 712 is enabled by condition VC0<VC0th 718 in state AND 714. The pulse can then be fed through to the inverter by the driver means so that the converter will react in terms of VC and updated control error as indicated in state VC, Δvo(system) 716. Arrow NOM simply indicates that in case of nominal operation the NOM block controls the driver voltages. VC is filtered in state VC0=F(VC) 710 (e.g. as indicated by the Diode-R-C in 710), which represents its peak value that however decreases from oscillation period to period depending on the present damping and resonant frequency (f0). VC is further evaluated in terms of negative zero crossing detection in state NZC 708. In case of such a zero crossing and if VC0 is low enough (as controlled in the outer loop FIG. 6) the pulse with a length Ton (as also controlled there) is again given to the driver (which then further may introduce e.g. a preset dead time).

The foregoing merely illustrates the principles of the invention. It will thus be appreciated that those skilled in the art will be able to devise various arrangements which, although not explicitly described or shown herein, embody the principles of the invention and are thus within its spirit and scope. For example, one of ordinary in the art will recognize that the particular structures shown in the figures are presented for ease of understanding, and that the functions of the various blocks may be performed by other blocks.

These and other embodiments will be evident to one ordinary in the art in view of this disclosure, and are included within the scope of the following claims.

1. A method of operating a resonant power supply (100, 250, 400), the method comprising:
switching the resonant power supply at a frequency (208) below Resonance Frequency of the resonant power supply; and
employing zero voltage switching (310),
wherein the method applies to at least one of:
a light load operation mode of the resonant power supply; and
a low power standby mode of the resonant power supply.

2. The method of operating a resonant power supply of claim 1, wherein the resonant power supply comprises a dual output control and wherein an output of the resonant power supply comprises a quasi switch-off circuitry.

3. An integrated circuit for driving a resonant power supply (100, 250, 400) comprising at least one of:
a control block (252);
a driver (254); and
an inverter (256),
wherein the integrated circuit enables:
switching the resonant power supply at a frequency (208) below Resonance Frequency of the resonant power supply; and
employing zero voltage switching (310),
and wherein the integrated circuit enables at least one of:
a light load operation mode of the resonant power supply; and
a low power standby mode of the resonant power supply.

4. The integrated circuit of claim 3, wherein the integrated circuit enables control of a resonant power supply that comprises a dual output control and wherein an output of the resonant power supply comprises a quasi switch-off circuitry.

5. A resonant power supply (100, 250, 400) comprising:
means for switching the resonant power supply at a frequency (208) below Resonance Frequency of the resonant power supply; and
means for employing zero voltage switching (310),
wherein the resonant power supply is enabled to operate in at least one of:
a light load operation mode; and - a low power standby mode.

6. The resonant power supply of claim 5, wherein the resonant power supply further comprises a dual output control and wherein an output of the resonant power supply comprises a quasi switch-off circuitry.
